(19) United States
(12) Patent Application Publication
(10) Pub. No.: US 2007/0019405 A1
(43) Pub. Date: Jan. 25, 2007

(54) High-duration of illumination portable lighting device having manually actuated generator

(76) Inventors: Chung-Ming Chang, Taipei (TW); Tung-Tsai Chang, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/184,953

(22) Filed: Jul. 20, 2005

(51) Int. Cl. F21V 21/00

(52) U.S. Cl. 362/192; 362/249

(57) ABSTRACT

A portable long-running lighting device having a manual power generator of the present invention can generate electricity effectively and also can radiate for a long time. The portable long-running lighting device includes a manual power generator module, an electricity storage module, an LED (light-emitting diode) module and a housing. The manual power generator module includes an electricity generator, a transmission mechanism and a base. The electricity storage module is coupled to an electricity generator of the manual power generator module. The LED module includes a plurality of light-emitting diodes and a circuit. The circuit further includes a power saving circuit coupled between the electricity storage module and the light-emitting diodes. With a three-stage discharge mode, a discharge speed of the electricity storage module can be stabilized, so as to achieve an electricity saving effect.

### BACKGROUND OF THE INVENTION

1. Field of the Invention

The invention relates in general to a portable lighting device, and more particularly to a high-duration of illumination portable lighting device having a manually actuated generator and being capable of long-lasting use.

2. Description of the Related Art

The conventional portable electric lamp, such as a conventional flashlight, acquires a power from a source within the flashlight, such as dry cell batteries, an accumulator or rechargeable batteries. However, the flashlight batteries tend to experience a harmful chemical reaction after a certain amount of time has elapsed, and a corrosive liquid may leak. In the aforesaid case, the batteries not only fail to provide the power source, but also may corrode the inner workings of the flashlight. Thus, not only may the flashlight not be functional at the exact moment it is needed, it also may be permanently useless whereby fresh batteries cannot resolve the situation. Moreover, the batteries are indeed not a good product in terms of environmental protection. Recycling of the batteries is very crucial. However, even recyclable batteries eventually become ineffective and they, together with single-charge batteries represent a serious contamination to the environment. Vast amounts of batteries are used every day all over the world such that it is impossible for them to be all safely disposed of, such that any way to reduce appliances conventionally fitted with batteries is earnestly sought.

In view of the above-described drawbacks of the flashlight, the flashlight with a power supply alternative to the batteries is available in the market. A manual power generator is applied to store the electricity in a circuit, so as to make this flashlight radiate light. However, the electricity generated by the manual power generator is always insufficient, hence the flashlight cannot radiate timely. Besides, the circuit cannot function well to store the electricity efficiently. Therefore the flashlight can just radiate for a very short time after consuming a lot of effort and time to operate the manual power generator.

### SUMMARY OF THE INVENTION

It is therefore an objective of the present invention to provide a high-duration of illumination portable lighting device having a manually actuated generator of the present invention to generate electricity effectively.

In order to achieve the above-mentioned objective, the portable long-running lighting device having a manual power generator mainly includes a manual power generator module, an electricity storage module, an LED (light - emitting diode) module and a housing. The manual power generator module includes an electricity generator, a transmission mechanism and a base. The electricity generator is configured above the transmission mechanism and the transmission mechanism is configured inside the base. The electricity storage module is coupled to the electricity generator of the manual power generator module. The LED module includes a plurality of light-emitting diodes and a circuit. The circuit further includes a power saving circuit coupled between the electricity storage module and the light-emitting diodes. The manual power generator module, the electricity storage module and the LED module are configured inside the housing. With a three-stage discharge mode, a discharge speed of the electricity storage module can be stabilized, so as to achieve an electricity saving effect.

Furthermore, the power saving circuit includes an oscillating circuit. The oscillating circuit includes a plurality of resistors R3 to R7, a plurality of capacitances C5 and C6, a plurality of NPN transistors Q1 and Q3 and a PNP transistor Q2. An emitter of the transistor Q1 is coupled to the emitter of the transistor Q2, a base of the transistor Q1 is parallel-connected to the resistor R4 and the capacitance C5, a base of the transistor Q2 is parallel-connected to the resistor R5 and the capacitance C6, a collector of the transistor Q1, the resistor R4 and the capacitance C2 are coupled to the resistor R3. The resistor R1 is further coupled to the electricity storage module and the light-emitting diodes. The base of the transistor Q3 coupled to the resistor R7 together with the collector of the transistor Q2 is connected to the ground via the resistor R6, and the collector of the transistor Q3 is coupled to the light-emitting diodes.

### BRIEF DESCRIPTION OF THE DRAWING

FIG. 1 shows an exploded perspective view of an example of a portable long-running lighting device having a manual power generator of a preferred embodiment of the present invention.

FIG. 2 shows a perspective view of an example of a portable long-running lighting device having a manual power generator of a preferred embodiment of the present invention.

FIG. 3 shows an exploded perspective view of a manual power generator module of the present invention.

FIG.4 shows a cross-sectional side view of a manual power generator module of the present invention.

FIG.5 shows a circuit diagram of an electricity storage module and a sectional discharge circuit of the present invention.

FIG.6 shows a circuit diagram of an oscillating circuit of the present invention.

### DETAILED DESCRIPTION OF THE INVENTION

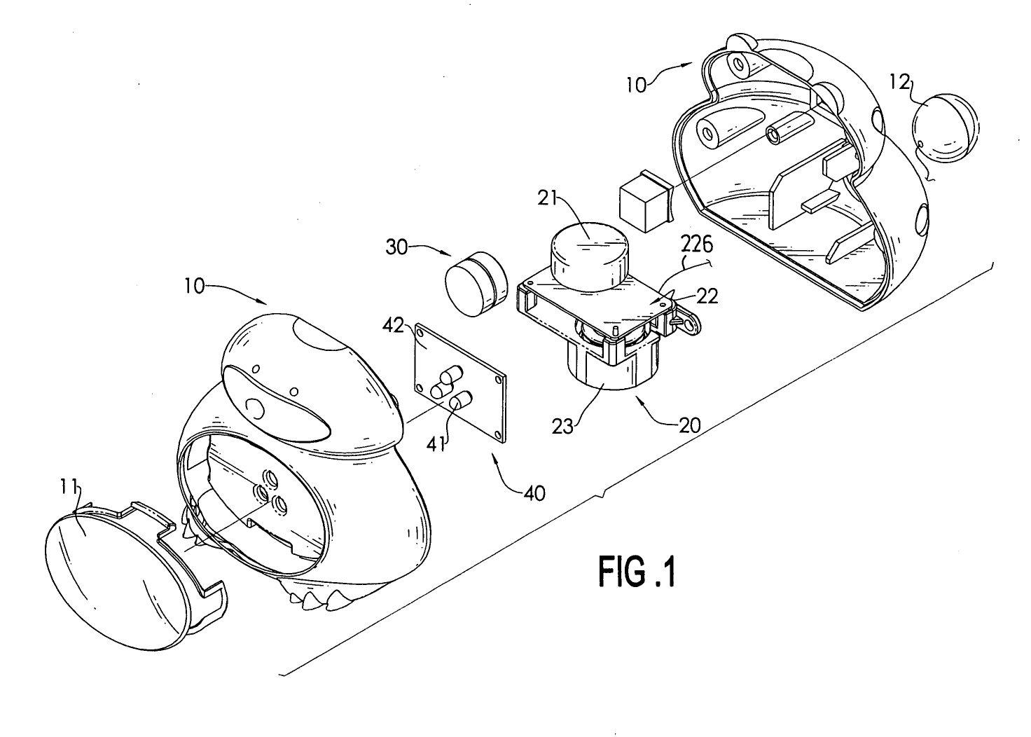

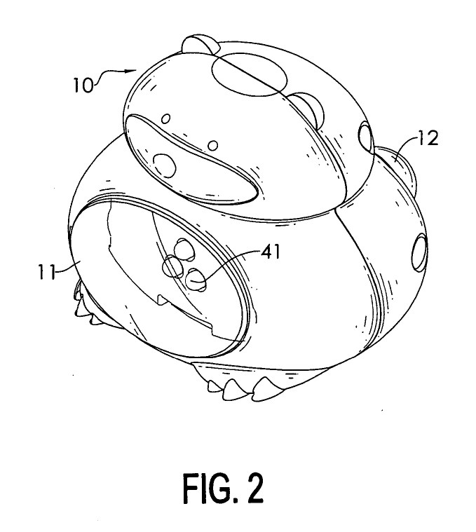

Referring to FIG. 1 and FIG. 2, an example of a preferred embodiment of a portable long-running lighting device having a manual power generator of the present invention mainly includes a manual power generator module 20, an electricity storage module 30, an LED (light-emitting diode) module 40 and a housing 10.

The manual power generator module 20 includes an electricity generator 21, a transmission mechanism 22 and a base 23. The electricity generator 21 is configured above the transmission mechanism 22. The transmission mechanism is configured inside the base 23. Moreover, the transmission mechanism 22 is able to be secured locked inside the base 23.

The electricity storage module 30 is a chargeable capacitor module. The electricity storage module 30 is coupled to the electricity generator 21 of the manual power generator module, so as to store electricity generated by the electricity generator 21.

The LED module 40 includes multiple light-emitting diodes 41 and a circuit 42. The circuit 42 includes a power saving circuit (not shown in the diagrams) coupled between the electricity storage module 30 and the light-emitting diodes 41.

The housing 10 is made up of a front housing and a back housing. The housing 10 can be configured as one of a variety of forms and although a toy bear is shown in the figures, the invention is not limited thereto. A transparent lampshade is configured at an abdomen of the toy bear, and a tail of the toy bear forms an independent sphere 12. The manual power generator module 20, the electricity storage module 30 and the LED module 40 are configured inside the housing 10.

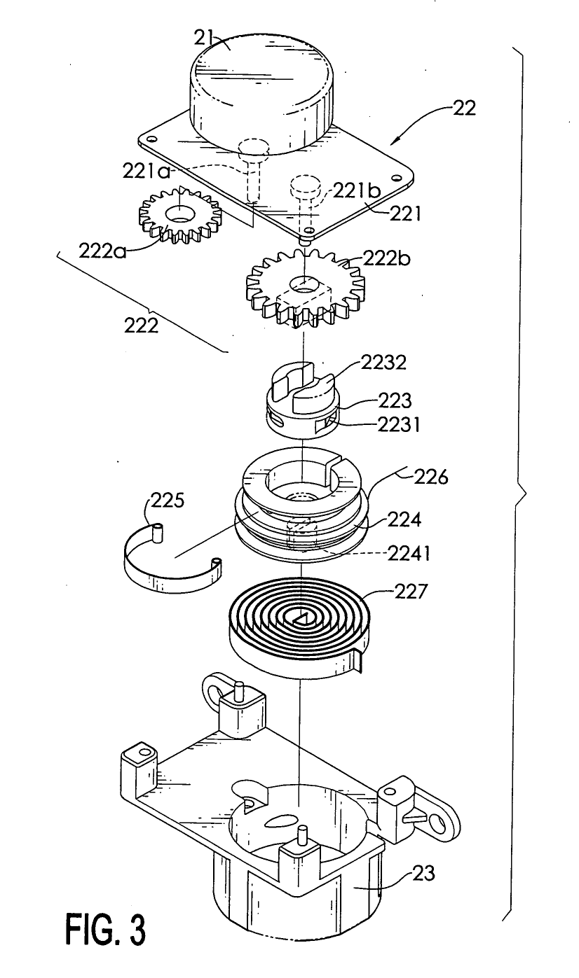

Referring to FIG. 3, the transmission mechanism 22 includes a gear wheel base 221, a transmission gear module 222, a rotation transmission shaft 223, a transmission connector 224, a jack strip 225, a pull string 226 and a coil spring 227. Moreover, the electricity generator 21 is a power generator configured on a top of the gear wheel base 221.

The gear wheel base 221 is a rectangular board. A plurality of gear wheel shafts 221a, 221b are configured at a bottom of the gear wheel base 221. One of the gear wheel shafts 221a is located at an axis of the electricity generator 21.

The transmission gear module 222 includes a plurality of gears 222a, 222b to mount on the gear wheel shafts 221a, 221b. Two adjacent gears can engage with each other.

The transmission shaft 223 forming a cylindrical shape is coupled to the gear 221b. Four pinholes 2231 are located along an external periphery of the transmission shaft 223 with adjacent pinholes 2231 being perpendicular to each other. A wedge 2232 extends upward on a top of the transmission shaft 223 for meshing with the gear 221b.

The transmission connector 224 forms a cylinder-like shape and is coaxial with the transmission shaft 223. A coaxial circular trench having a smaller diameter than an external diameter of the transmission connector 224 is formed on a top of the transmission connector 224 for receiving the transmission shaft 223. A gap is formed at an edge of the trench. A coaxial protruding column 2241 is formed on a bottom of the transmission connector 224. An end of the jack strip 225 catches the transmission connector 224, and the other end the jack strip 225 extends to the transmission connector 224 via the gap of the transmission connector 224 to engage with a respective one of the pinholes 2231 on the external periphery of the transmission shaft 223. The pull string 226 winds around the transmission connector 224 and extends outside the housing 10 to be connected with the sphere 12.

An end of the coil spring 227 is secured to the protruding column 2241 of the bottom of the transmission connector 224.

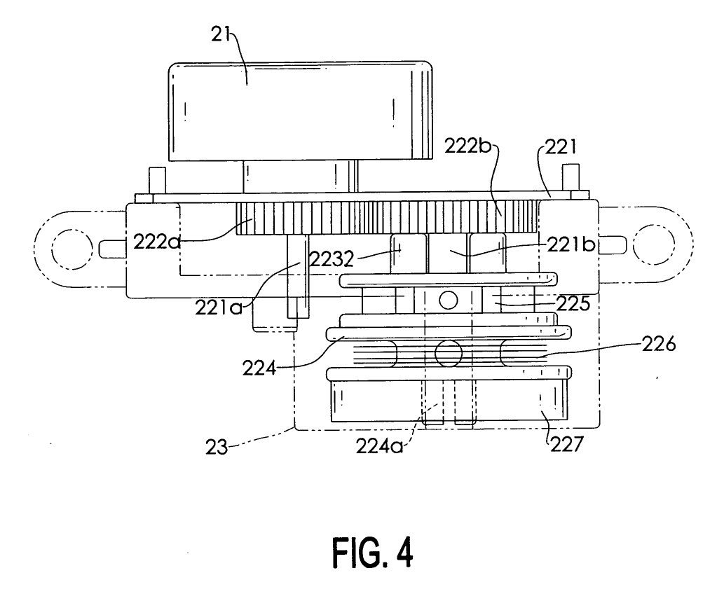

The base 23 includes a circular recess for securing the other end of a coil spring 227. The transmission mechanism 22 is secured on the circular recess by locking the gear wheel base 221 to the circular recess with multiple locking holes as shown in FIG. 4.

An operation of the manual power generator module 20 is to pull the sphere 12, so that the pull string 226 is drawn out of the housing 10, to drive the transmission shaft 223 and the transmission connector 224 to rotate and to bind up the coil spring 227. At this moment, the jack strip 225 does not stop the transmission shaft 223 and the gear 222b from rotating. With the gears 222a and 222b to be meshed with each other, a magnetic axle inside the electricity generator 21 is driven to rotate to generate electricity. If the sphere 12 is released, the pull string 226 is also released, so that the constricted coil spring 227 makes the transmission connector 224 rotate counterclockwise due to an elastic counterforce. When the pull string 226 returns into the body 10, the jack strip 225 stops the rotation transmission shaft 223 and the gear 222b by catching one of the pinholes 2231 on the rotation transmission shaft 223.

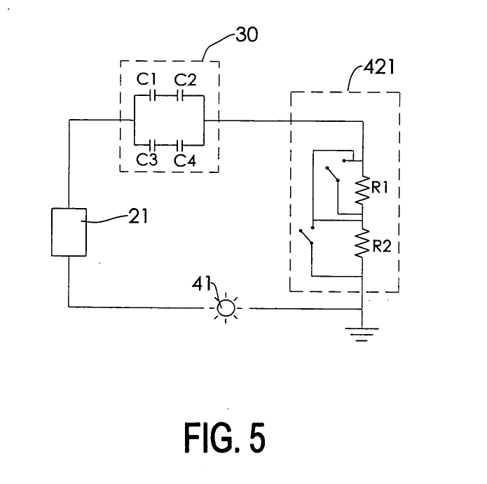

Referring to FIG. 5, the electricity storage module 30 includes multiple capacitances C1 to C4. C1 is series-connected to C2, and C3 is series-connected to C4, so that a voltage is to add up the two connected capacitances respectively. The two series connections are then parallel-connected, so that the voltage of the two series connections is lower than the voltage of the electricity generator 21. In this way, the electricity generated by the electricity generator 21 can be stored to the electricity storage module 30 easily.

The sectional discharge circuit 421 includes two series-connected resistors R1, R2 and two switches as shown in FIG. 5. An input terminal of the sectional discharge circuit 421 is coupled to the electricity storage module 30, and an output terminal of the sectional discharge circuit 421 is coupled to the light-emitting diodes 41. One of the switches is cross-connected to two terminals of the resistor R1, and the other one of the switches is cross-connected to external nodes of the resistors R1 and R2.

When the capacitances are discharged, a decrease speed of an electric current is correlative with the capacitances and the resistors. That is to say, the bigger a product of the capacitances and the resistors, the slower the discharge speed. Hence when the electricity storage module 30 is fully charged and the two switches are closed, the electric current passes from the electricity storage module 30 via the resistors R1, R2 to the light-emitting diodes 41. At this moment, a resistance value of the power line is a sum of the two resistors, so as to decrease the discharge speed of the electricity storage module 30. If the voltage of the electricity storage module 30 drops to 3 volts, the switch cross-connected to the resistor R1 is then opened, so that the resistance for the flowing electric current is only R2. Thus the discharge speed of the electricity storage module 30 increases slightly. If the voltage of the electricity storage module 30 drops to 1.5 volts, the two switches are then both opened. Thus the resistance for the flowing electric current is approaching zero and the discharge speed of the electricity storage module 30 is very fast. With the above-described three-stage discharge mode, the discharge speed of the electricity storage module 30 can be stabilized, so as to achieve an electricity saving effect.

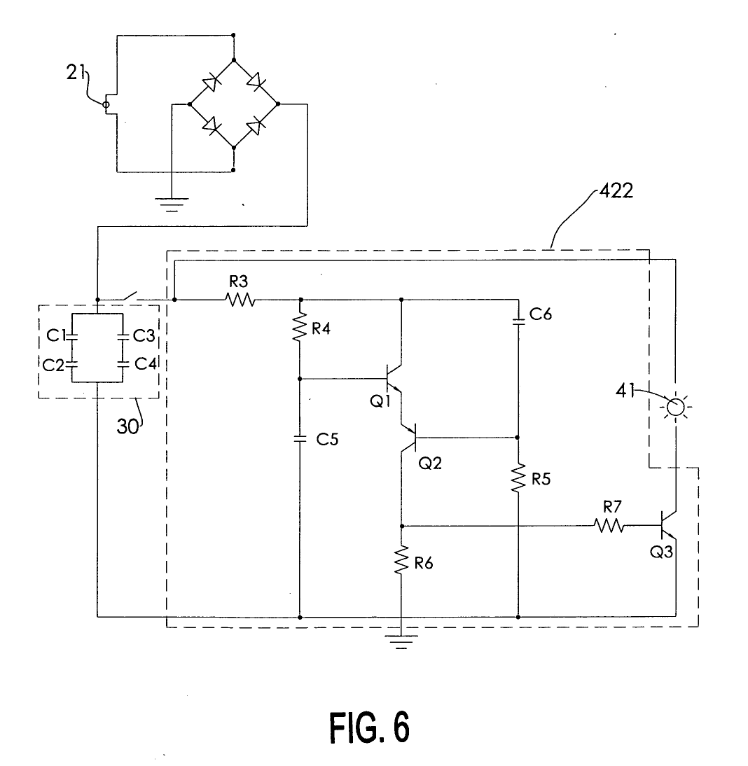

Referring to FIG. 6, the oscillating circuit 422 includes multiple resistors R3 to R7, multiple capacitances C5 and C6, multiple NPN transistors Q1 and Q3 and a PNP transistor Q2. The electricity generated by the electricity generator 21 is rectified by a bridge rectifier, and then input to the electricity storage module 30 and the oscillating circuit 422. Bases of Q1 and Q2 are coupled with an RC circuit respectively, and the resistor R3 is coupled to an output terminal of the electricity storage module 30. The base of the transistor Q3 coupled to the resistor R7 together with the collector of the transistor Q2 is connected to the ground via the resistor R6.

The oscillating circuit 422 recharges the RC circuit by discharging the electricity storage module 30 until the voltage of the RC circuit is sufficient to conduct transistors Q1 and Q2, and also to conduct transistor Q3. At this moment, the light-emitting diodes 41 radiate light. Once the RC circuit discharges the stored electricity, transistor Q3 is closed, so that the light-emitting diodes 41 do not radiate the light. Then the RC circuit is recharged immediately. The well-known ‘retention of image in human vision’ phenomenon can be calculated such that the time required for the RC circuit to be charged is in accordance with that phenomenon in this circumstance. Once the RC circuit is fully recharged, the light-emitting diodes 41 radiate the light again. In this way, the light-emitting diodes 41 can change light and dim statuses very speedily with an appropriate frequency by making use of the principle of the retention of image of human vision, so as to achieve the power saving effect.

According to the above description, is can be understood that the electricity can be generated easily by making good use of the manual power generator module. The generated electricity can be stored in the electricity storage module. The current can be stable and is prevented by the three-stage discharge mode from flowing away very soon. The power saving effect can be achieved by utilizing the retention of image of human vision phenomenon with the oscillating circuit generating the appropriate frequency to speedily control the light and dim statuses of the light-emitting diodes.

To conclude, the portable long-running lighting device having a manual power generator of the present invention includes the feature of non-obviousness, and also is not in public use, so as to meet the requirements to apply a new patent.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A high-duration of illumination portable lighting device having a manually actuated generator, the portable light device comprising:
a manual power generator module;
an electricity storage module coupled to the electricity generator of the manual power generator module;
an LED (light-emitting diode) module comprising a plurality of light-emitting diodes and a circuit, wherein the circuit comprises a power saving circuit coupled between the electricity storage module and the light-emitting diodes;
a housing, wherein the manual power generator module, the electricity storage module and the LED module are configured inside the housing.

2. The high-duration of illumination portable lighting device having the manually actuated generator as claimed in claim 1, wherein the manual power generator module comprises an electricity generator, a transmission mechanism and a base, wherein the electricity generator is configured above the transmission mechanism and the transmission mechanism is configured inside the base.

3. The high-duration of illumination portable lighting device having the manually actuated generator as claimed in claim 2, wherein the transmission mechanism from a top to a bottom comprises a gear wheel base, a transmission gear module, a rotation transmission shaft, a transmission connector, a jack strip, a pull string and a coil spring.

4. The high-duration of illumination portable lighting device having the manually actuated generator as claimed in claim 3, wherein the electricity generator is configured on a top of the gear wheel base, wherein a plurality of gear wheel shafts are configured at a bottom of the gear wheel base, wherein one of the gear wheel shafts is located at an axle of the electricity generator.

5. The high-duration of illumination portable lighting device having the manually actuated generator as claimed in claim 4, wherein the transmission gear module comprises a plurality of gears to mount on the gear wheel shafts, wherein two adjacent gears engage with each other.

6. The high-duration of illumination portable lighting device having the manually actuated generator as claimed in claim 5, wherein the rotation transmission shaft is coupled to the gears, wherein four pinholes are located along an external periphery of the rotation transmission shaft with adjacent pinholes being perpendicular to each other.

7. The high-duration of illumination portable lighting device having the manually actuated generator as claimed in claim 6, wherein the transmission connector forms a cylinder-like shape and is coaxial with one of the gears of the transmission gear module, wherein a coaxial circular trench having a smaller diameter than an external diameter of the transmission connector is formed on a top of the transmission connector for receiving the rotation transmission shaft, wherein a gap is formed at an edge of the trench, wherein a coaxial protruding column is formed on a bottom of the transmission connector, wherein an end of the jack strip catches the transmission connector, and the other end of the jack strip extends to the transmission connector via the gap of the transmission connector to engage with a respective one of the pinholes on the external periphery of the rotation transmission shaft, wherein the pull string winds around the transmission connector and extends outside the housing.

8. The high-duration of illumination portable lighting device having the manually actuated generator as claimed in claim 7, wherein an end of the coil spring is secured to the protruding column of the bottom of the transmission connector.

9. The high-duration of illumination portable lighting device having the manually actuated generator as claimed in claim 1, wherein the electricity storage module comprises a plurality of capacitances to be series-parallel connected to each other.

10. The high-duration of illumination portable lighting device having the manually actuated generator as claimed in claim 2, wherein the base comprises a circular recess for securing an end of a coil spring, wherein the transmission mechanism is secured on the circular recess by locking the gear wheel base to the circular recess.

11. The high-duration of illumination portable lighting device having the manually actuated generator as claimed in claim 1, wherein the power saving circuit comprises a sectional discharge circuit, wherein an input terminal of the power saving circuit is coupled to the electricity storage module, and an output terminal of the power saving circuit is coupled to the light-emitting diodes, wherein the sectional discharge circuit comprises at least two series-connected resistors R1, R2 and two switches, wherein the two switches are cross-connected to two terminals of the two resistors.

12. The high-duration of illumination portable lighting device having the manually actuated generator as claimed in claim 1, wherein the power saving circuit comprises an oscillating circuit, wherein the oscillating circuit comprises a plurality of resistors R3 to R7, a plurality of capacitances C5 and C6, a plurality of NPN transistors Q1 and Q3 and a PNP transistor Q2, wherein an emitter of the transistor Q1 is coupled to the emitter of the transistor Q2, a base of the transistor Q1 is parallel-connected to the resistor R4 and the capacitance C5, a base of the transistor Q2 is parallel-connected to the resistor R5 and the capacitance C6, a collector of the transistor Q1, the resistor R4 and the capacitance C2 are coupled to the resistor R3, wherein the resistor R1 is further coupled to the electricity storage module and the light-emitting diodes, wherein the base of the transistor Q3 coupled to the resistor R7 together with the collector of the transistor Q2 are connected to the ground via the resistor R6, and the collector of the transistor Q3 is coupled to the light-emitting diodes.

13. The high-duration of illumination portable lighting device having the manually actuated generator as claimed in claim 11, wherein the power saving circuit comprises an oscillating circuit, wherein the oscillating circuit comprises a plurality of resistors R3 to R7, a plurality of capacitances C5 and C6, a plurality of NPN transistors Q1 and Q3 and a PNP transistor Q2, wherein an emitter of the transistor Q1 is coupled to the emitter of the transistor Q2, a base of the transistor Q1 is parallel-connected to the resistor R4 and the capacitance C5, a base of the transistor Q2 is parallel-connected to the resistor R5 and the capacitance C6, a collector of the transistor Q1, the resistor R4 and the capacitance C2 are coupled to the resistor R3, wherein the resistor R1 is further coupled to the electricity storage module and the light-emitting diodes, wherein the base of the transistor Q3 coupled to the resistor R7 together with the collector of the transistor Q2 is connected to the ground via the resistor R6, and the collector of the transistor Q3 is coupled to the light-emitting diodes.
